(19) United States
(12) Patent Application Publication
(10) Pub. No.: US 2006/0136255 A1
(43) Pub. Date: Jun. 22, 2006

(54) Method and system for metering usage of software products with fast run-time identification

(76) Inventors: Marco Mechelli, Rome (IT); Guido Maria Miconi, S Felice D'Ocre (AQ) (IT); Bernardo Pastorelli, L'Aquila (IT)

Correspondence Address: IBM CORPORATION;INTELLECTUAL PROPERTY LAW, 11400 BURNET ROAD, AUSTIN, TX, 78758, US

(21) Appl. No.: 11/301,416

(22) Filed: Dec. 13, 2005

(30) Foreign Application Priority Data
Dec. 21, 2004 (EP) 04106799.2

(51) Int. Cl. G06Q 99/00

(52) U.S. Cl. 705/1

(57) ABSTRACT

A method (300) for metering usage of software products in a data processing system is proposed. The products to be metered are identified in a global catalogue (325) by means of multiple attributes of a corresponding executable module (340); the verification of these attributes requires accessing the module through its path, which is not available at run-time (being the module directly identified by a corresponding location for performance reasons) . The solution is based on the idea of creating a local catalogue (350) that associates the path of each module installed on the system (that is included in the global catalogue) with its location. The locations of the running modules are detected (365) periodically from a list of processes in execution on the system. In this way, it is possible to obtain (355) the path corresponding to the location of each running module in a very fast way trough the local catalogue (without any scanning of the system). The running module can now be accessed (360) for extracting its attributes required for the identification of the corresponding product in the global catalogue.

### TECHNICAL FIELD

The present invention relates to the data processing field. More specifically, the present invention relates to the metering of software product usage in a data processing system. Particularly, the invention is aimed at facilitating the run-time identification of the products in use on the system.

### BACKGROUND ART

Software products (such as computer programs) can be perfectly reproduced in an infinite number of copies. This is a major concern for publishers of the products wishing to protect their intellectual property rights; indeed, the publishers typically receive a royalty for a licensed use of each product, so that any unaccounted use or distribution of the product results in unpaid royalties. The problem has been exacerbated in the last years by the widespread diffusion of the Internet, which further facilitates the uncontrolled distribution of this kind of products.

The most straightforward way of avoiding unaccounted usage of the products is that of preventing unauthorized copying and transmission. For example, some products embed control code that limits the number of copies that can be made or disables operation of the products after a predetermined period of time has lapsed. Another technique consists of requiring possession of a software or hardware key for running the products. A different solution consists of instrumenting each product to call a licensing management system, which verifies whether the usage of the product is authorized and then allows the product to start or forces it to stop accordingly.

However, the above-described techniques are quite invasive, since they require the publishers to modify each product. Moreover, those solutions are not of general applicability, and are completely ineffective in metering the usage of pre-existing products.

A different approach is based on the use of a software catalogue. The software catalogue lists all the products of interest (to be metered); each product is associated with one or more executable modules, which indicate the usage of the product when running. In this case, a licensing agent working in the background periodically detects the modules that are running; the licensing agent then identifies the corresponding products in use through the software catalogue. The licensing agent may then close any process corresponding to a product that is not authorized to run (so as to stop its execution), and may make the product unable to start again. Alternatively, as described in WO-A-03038570, the licensing agent detects any new process that is started in response to the request of execution of a product (for example, using a kernel hooking technique). The process is suspended for verifying the authorization to run the corresponding product. In this case, if the authorization is granted the process is resumed so as to enable the product to start; otherwise, the process is aborted so as to prevent the use of the product (thereby avoiding closing the process while it is performing potentially risky operations)

Typically, each module is identified in the software catalogue by means of multiple attributes (such its name, size and checksum). In this way, it is possible to identify the products in use with a high degree of accuracy (strongly reducing the probability of any false identification). Moreover, the multiple attributes allow discriminating different versions of the same product (which are typically based on modules with an identical name).

A problem of the solution described above is that the licensing agent must access each module running on the system for retrieving its attributes (for example, to open it and calculate the necessary information). This operation requires the knowledge of a full path of the running module, in order to reach the running module through the typical tree structure of every file system. Nevertheless, for performance reasons, in most operating systems the running module is identified through a corresponding location; the location directly points to the running module, without the need to traverse the whole tree. In this case, however, the path of the running module cannot be derived from its location in a straightforward way (since usually the tree cannot be traversed backwards from the running module to its root).

Therefore, the licensing agent must scan the whole tree to identify the path associated with the location of each running module (in order to access it for retrieving the required attributes). This process is very time consuming and wastes a significant amount of system resources.

The above-mentioned drawback is particular acute when the licensing agent detects the running modules periodically. Indeed, in this case the running modules cannot be verified with a high frequency (for their authorizations). This has a detrimental effect on the accuracy of the process of metering the products that are in use.

### SUMMARY OF THE INVENTION

According to the present invention, the idea of associating the locations with the paths for the fast run-time identification of the corresponding modules is suggested.

Particularly, an aspect of the invention provides a method for metering usage of software products in a data processing system. The method starts with the step of providing a global catalogue; the global catalogue associates each product to be metered with one or more executable modules, which indicate the usage of the product when running. A local catalogue associating a path (for accessing each module installed on the system that is included in the global catalogue) with a location (for identifying the module when running) is created. The method then involves the step of detecting the location of each module running on the system. The path associated with the location of each running module is now determined according to the local catalogue. Each running module can then be accessed through the corresponding path, in order to identify the product associated with the running module according to the global catalogue.

In this way, each running module can be accessed directly (without the need of scanning the system for retrieving the path associated with the corresponding location). The process is then very fast and does not involve the waste of significant system resources.

Without detracting from its general applicability, the proposed solution allows verifying the running modules periodically (for their authorizations) with a very high frequency, without adversely affecting the performance of the system. This strongly increases the accuracy of the process of metering the products that are in use.

The different embodiments of the invention described in the following provide additional advantages.

For example, the solution of the invention is particularly advantageous when a list of processes in execution on the system is periodically determined for detecting the locations of the running modules.

Indeed, in this case no alternative techniques are available for retrieving the corresponding paths (apart from scanning the system).

The proposed solution has been specifically designed for applications wherein each module is defined in the global catalogue by means of one or more attributes.

This allows retrieving the attributes of each running module directly (for its identification).

In a preferred embodiment of the invention, the local catalogue is created by scanning a mass memory of the system (for detecting the path and the location of each installed module); if the installed module is included in the global catalogue, this information is then added to the local catalogue.

The proposed process can be performed off-line.

As a further enhancement, whenever the location of a running module is not included in the local catalogue the mass memory is scanned for detecting the corresponding path; if the running module is included in the global catalogue, its path and location are added to the local catalogue.

This makes it possible to update the local catalogue at run-time for any module that has been installed after its creation.

A way to further improve the solution is to determine the actual location associated with the path extracted from the local catalogue (for the location of the running module), so as to verify whether the association is still valid.

This additional feature increases the accuracy of the identification (since it avoids wrong conclusions when the running module has been moved after the creation of the local catalogue); this result is achieved without any substantial performance degradation (being the operation of determining the location from the path very fast).

Advantageously, if the association is not valid any longer the information is removed from the local catalogue; the mass memory is then scanned for detecting the path associated with the location of the running module, and its path and location are added to the local catalogue (if the running module is included in the global catalogue).

This allows maintaining the local catalogue always up-to-date (even when any running module has been moved).

A further aspect of the present invention provides a computer program for performing the above-described method.

A still further aspect of the invention provides a program product embodying this computer program.

Another aspect of the invention provides a corresponding data processing system.

The characterizing features of the present invention are set forth in the appended claims. The invention itself, however, as well as further features and advantages thereof will be best understood by reference to the following detailed description, given purely by way of a non-restrictive indication, to be read in conjunction with the accompanying drawings.

### BRIEF DESCRIPTION OF THE DRAWINGS

FIG. 1a is a schematic block diagram of a data processing system in which the solution according to an embodiment of the invention is applicable;

FIG. 1b shows the functional blocks of a generic workstation of the system;

FIG. 2 is an illustrative representation of the structure of an exemplary file system of the workstation;

FIG. 3 depicts the main software components that can be used for practicing the solution according to an embodiment of the invention; FIGS. 4a-4d show a diagram describing the flow of activities relating to an illustrative implementation of the solution according to an embodiment of the invention.

### DETAILED DESCRIPTION OF THE PREFERRED EMBODIMENTS(S)

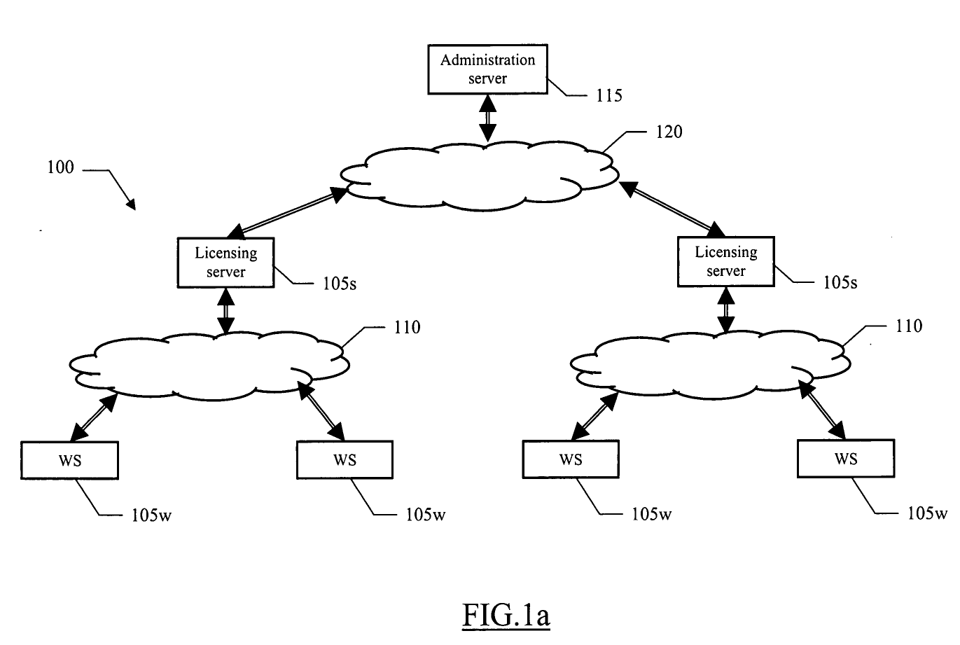

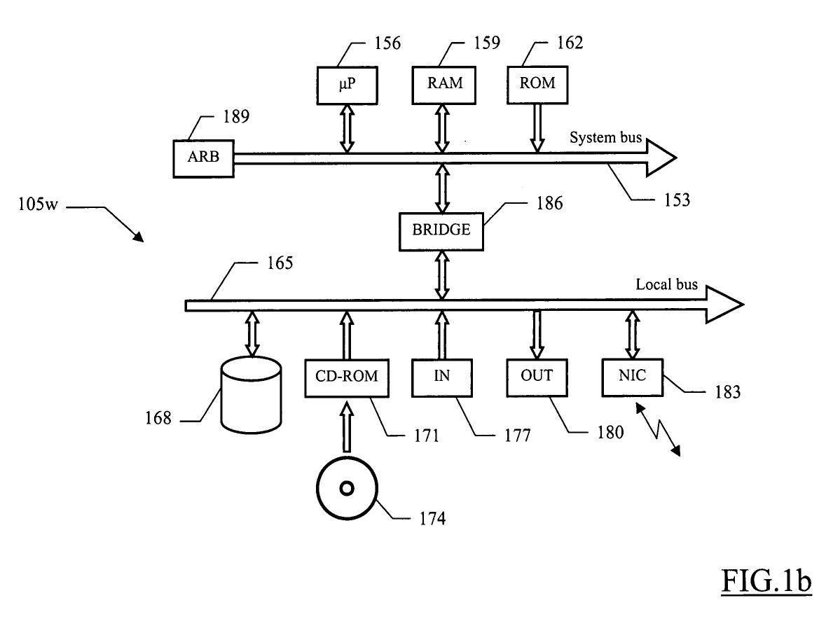

With reference in particular to FIG. 1a, a data processing system 100 with distributed architecture is depicted. The system 100 includes multiple workstations (WS) 105w, which are grouped into different sets; a licensing server 105s is associated with the workstations 105w of each set. The licensing server 105s and the corresponding workstations 105w are connected to each other through a network 110 (for example, a LAN). The different licensing servers 105s communicate with a remote administration server 115 through a different network 120 (for example, INTERNET-based); the administration server 115 implements a central repository where usage, procurement and inventory data of the system 100 is collected and managed.

As shown in FIG. 1b, a generic workstation 105w is formed by several units that are connected in parallel to a system bus 153. In detail, a microprocessor (μP) 156 controls operation of the workstation 105w; a RAM 159 is directly used as a working memory by the microprocessor 156, and a ROM 162 stores basic code for a bootstrap of the workstation 105w. Peripheral units are clustered around a local bus 165 (by means of respective interfaces). Particularly, a mass memory consists of a hard disk 168 and a drive 171 for reading CD-ROMs 174. Moreover, the workstation 105w includes input devices 177 (for example, a keyboard and a mouse), and output devices 180 (for example, a monitor and a printer). A Network Interface Card (NIC) 183 is used to connect the workstation 105w to the network. A bridge unit 186 interfaces the system bus 153 with the local bus 165. The microprocessor 156 and the bridge unit 186 can operate as master agents requesting an access to the system bus 153 for transmitting information. An arbiter 189 manages the granting of the access with mutual exclusion to the system bus 153.

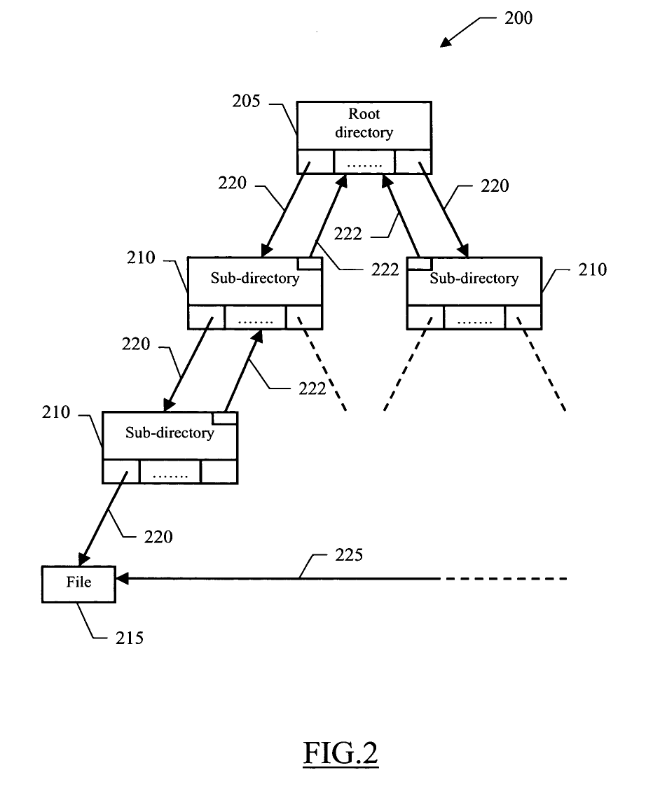

Moving now to FIG. 2, an operating system of the above-described workstation typically implements a file system with a hierarchical structure. Particularly, the file system is organized as a tree 200, starting from a root node 205 defining a (physical or logical) device, also referred to as root directory. Each intermediate node 210 (having one or more child nodes dependent thereon) defines a sub-directory. Leaf nodes (having no child nodes dependent thereon) are either empty sub-directories or files 215.

The root directory 205 and each sub-directory 210 include one or more forward pointers 220 to the corresponding child nodes (either consisting of sub-directories 210 or files 215); each sub-directory 210 further includes a backward pointer 222 to its parent node (i.e., another sub-directory 210 or the root directory 205). The pointers 220 allow traversing the tree 200 top-down (from the root directory 205 to any desired file 215). Particularly, each file 215 can be accessed by means of a corresponding path starting from the root directory 205 and reaching the file 215 through the interposed sub-directories (if any). For example, a file called “MyFile” that is listed in sub-directory “MyDir” dependent on root directory “MyRoot” is identified by the path “MyRoot\MyDir\MyFile”.

For performance reasons, the operating system of the workstation internally identifies each file 215 by means of a further pointer 225 (instead of its path). The pointer 225 defines a (logical) position of the file 215 on the hard disk; in this way, the operating system can access the file 215 directly without having to traverse the whole tree 200. For example, the location can consist of a number identifying a logical disk (also known as filesystem ID) and a number that is unique for the filesystem (also known as i-node). It should be noted that the files 215 include no backward pointer to the corresponding parent node; therefore, it is not possible to traverse the tree 200 from any file 215 to the root directory 205. It follows that the location 225 of each file 215 cannot be used to obtain its path; as a result, the location 225 is ineffective to access the file 215 from outside the operating system (by any application invoking its services).

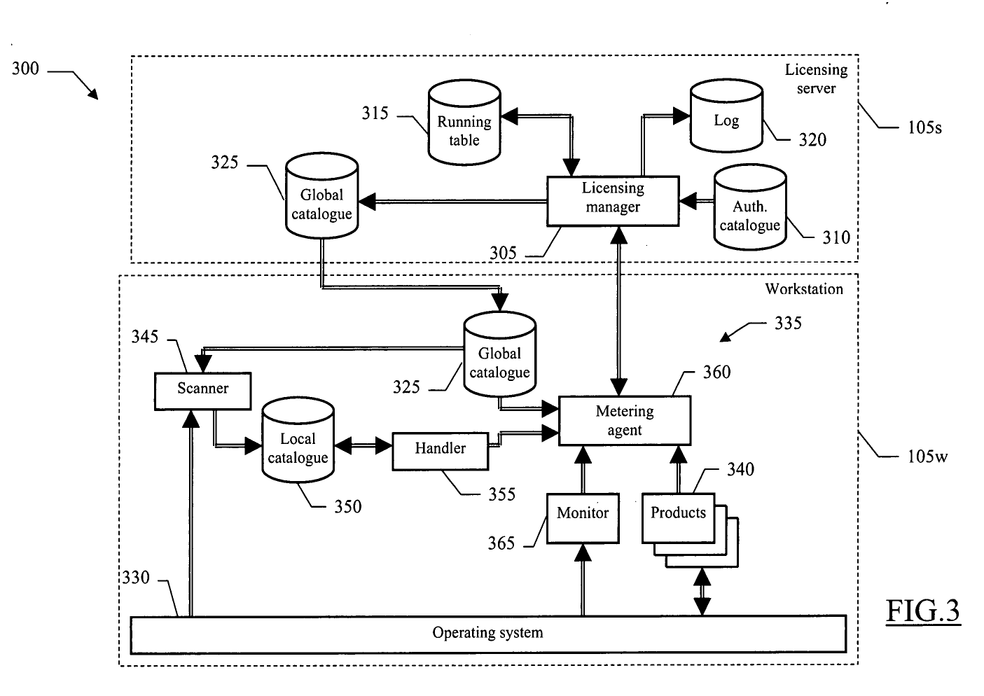

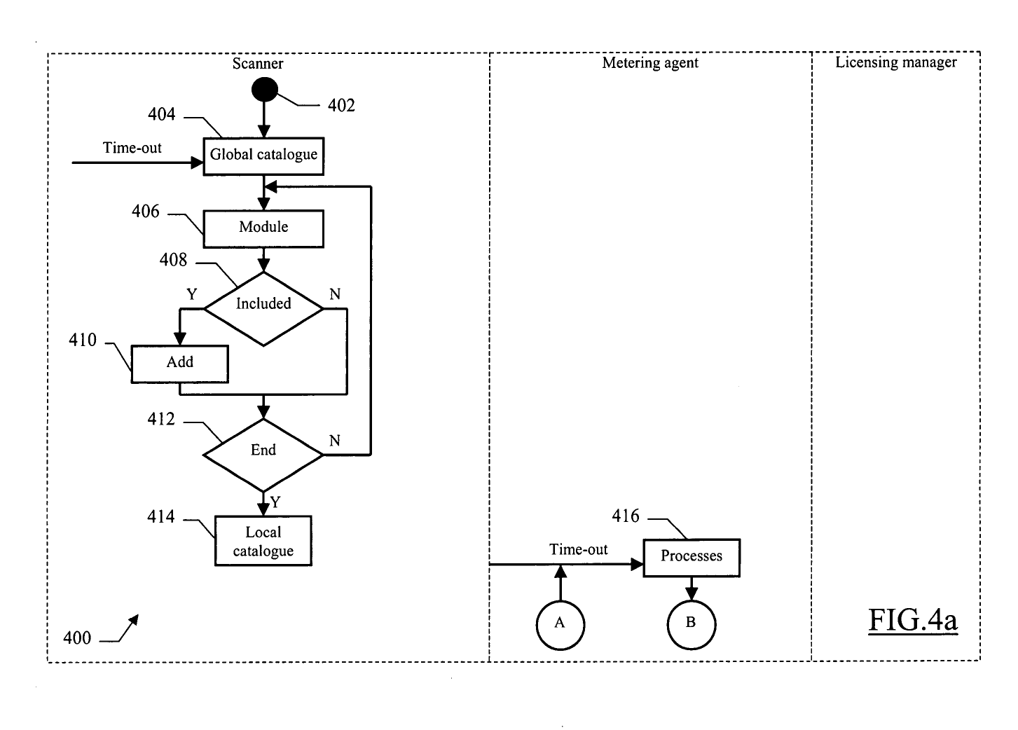

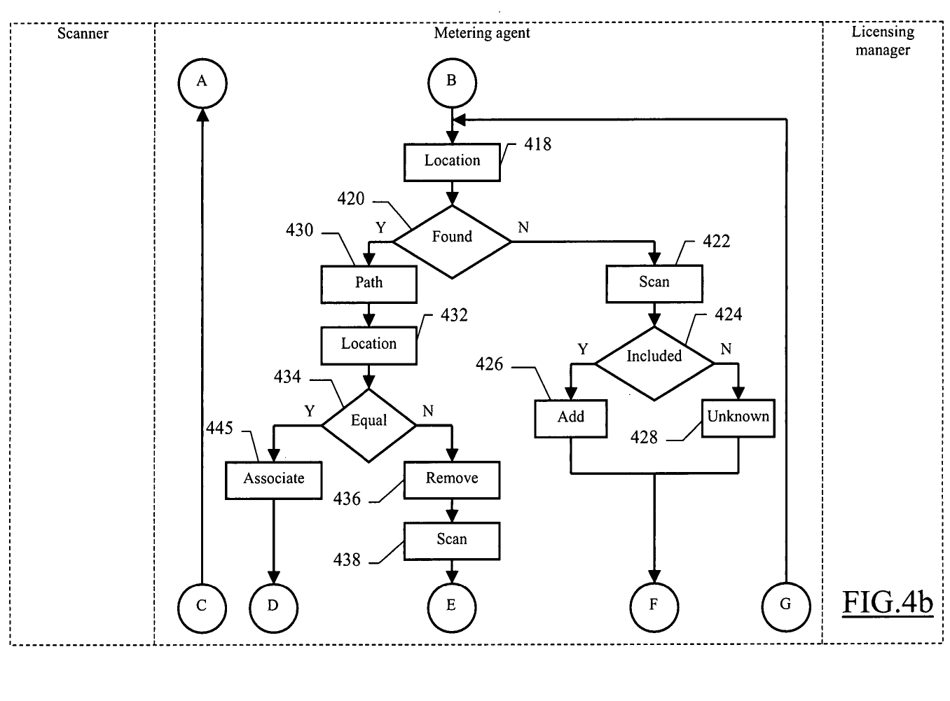

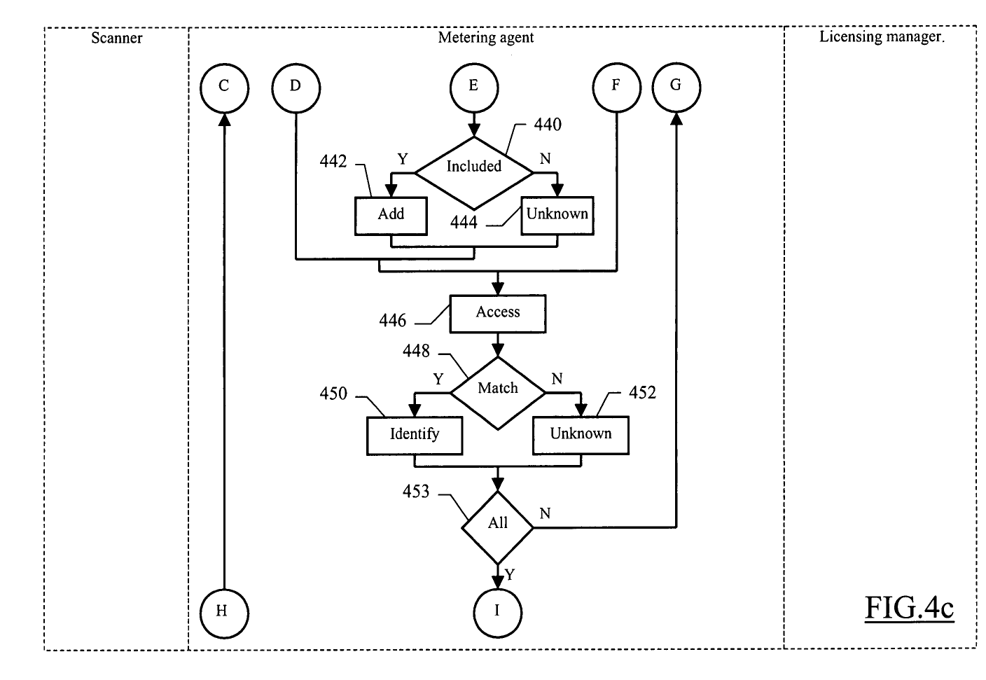

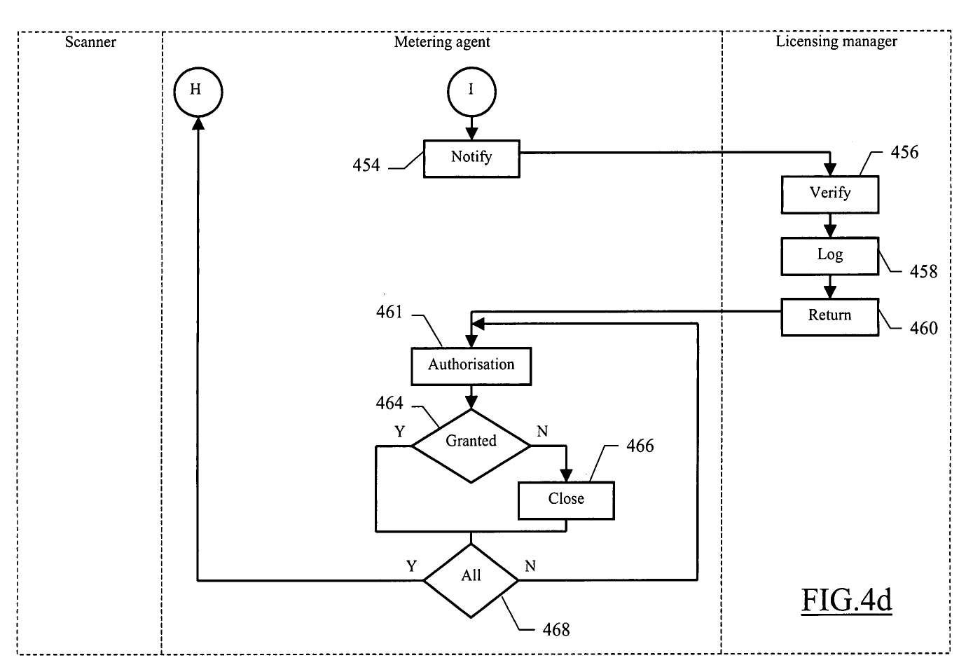

With reference to FIG. 3, the main software components that can be used for practicing the method (according to an embodiment of the invention) are collectively denoted with the reference 300. The information (programs and data) is typically stored on the hard disks and loaded (at least partially) into the corresponding working memories when the programs are running. The programs are initially installed onto the hard disks from CD-ROMs.

Considering in particular a generic licensing server 105s, a corresponding manager 305 controls the associated workstations. The licensing manager 305 accesses an authorization catalogue 310, which contains information about the authorized conditions of use of different software products; for example, the authorization catalogue 310 specifies the maximum processing power or the maximum capacity of the working memories of the workstations on which each product can run, the number of licenses for the product (defining the maximum number of instances of the product allowed to run concurrently), and the like. The licensing manager 305 also controls the entering of information into a running table 315, which lists the products currently in use on the workstations. In addition, the licensing manager 305 collects information from the corresponding workstations (for example, about the installed programs, any attempts to use non-authorized or unknown products, and the like); this information is stored into a corresponding log 320.

The licensing server 105s also stores a global software catalogue 325, which is distributed to all the associated workstations (for example, periodically or at any change thereof). The global catalogue 325 lists all the known products to be metered in the system. Each product is identified by a signature consisting of one or more executable modules, which indicate the usage of the product when running. Each module is specified in the global catalogue 325 by means of multiple attributes; typically, the module is identified by its name, size and checksum (so as improve the accuracy of the identification).

Considering now a generic workstation 105w, an operating system 330 provides a software platform on top of which any application program can run. Particularly, a licensing tool 335 is used to control the usage of any software products 340. Particularly, the licensing tool 335 includes the global catalogue 325 that is received from the licensing server 105s. The global catalogue 325 is accessed by a scanner 345. The module 345 scans the mass memory of the workstation 105w (through corresponding services provided by the operating system 330), in order to detect the path and the location of each module that is installed on the workstation 105w. The scanner 345 creates a local catalogue 350, which includes an entry for each installed module that is included in the global catalogue; the entry associates the path of the installed module with the corresponding location. For this purpose, the local catalogue 350 preferably consists of a hash table storing the paths as data and using the locations as keys; in this way, the path associated with each location can be extracted in a very fast way by simply accessing the entry addressed by the hash value of the location (calculated with the same hash function used to insert the path).

The local catalogue 350 so obtained is maintained by a handler 355. A metering agent 360 continually running in the background accesses the local catalogue 350 (through the handler 355) and the global catalogue 325. The metering agent 360 interfaces with a monitor 365. The monitor 365 queries the operating system 330 for obtaining a list of processes that are in execution on the workstation 105w; for each process, the monitor 365 retrieves the location of the corresponding module that is running (which information is immediately available being maintained by the operating system 330 internally). The locations of the running modules are then passed to the metering agent 360. The metering agent 360 in turn determines the path associated with the location of each running module (by means of the local catalogue 350). In this way, the metering agent 360 can access each running module for identifying the corresponding product 340 (by means of the global catalogue 325). The information so obtained is transmitted by the metering agent 360 to the licensing manager 305. The licensing manager 305 grants or denies the authorization to use each product (using the authorization catalogue 310 and the running table 315). The result of the operation is stored into the log 320 and it is returned to the metering agent 360 (updating the running table 315 if necessary); the metering agent 360 then controls the execution of the products 340 accordingly.

Considering now FIGS. 4a-4d, the logic flow of a metering method implemented in the above-described system is represented with a method 400. The method begins at the black start circle 402 in the swim-lane of the scanner. Continuing to block 404, a scanning of the mass memory of the workstation is initialized by loading the global catalogue; for example, this operation is performed whenever a new global catalogue is downloaded from the licensing server, or a predetermined time-out expires (for example, every week). The method then continues to block 406, wherein the whole tree of the file system is traversed top-down (starting from root directory); whenever a leaf node is reached and an executable module is found, a test is made at block 408 to verify whether the module is included in the global catalogue; preferably, this operation is performed simply searching a module having the same name (irrespective of its attributes). If so, the location of the installed module is determined at block 410, and an entry for the path and the location of the installed module is added to a new version of the local catalogue. The flow of activity then descends into block 412; the same point is also reached from block 408 directly if the installed module is not included in the global catalogue. The method verifies at block 412 whether the scanning of the mass memory has been completed (i.e., all the branches of the tree have been traversed thereby reaching every leaf node thereof) . If not, the flow of activity returns to block 406 for continuing the scanning of the mass memory. Conversely, the local catalogue (if any) is replaced with its new version so obtained.

Concurrently (in a completely asynchronous manner), the metering agent enters block 416 whenever a predefined time-out expires (for example, every minute); in this phase, the list of processes in execution on the workstation is determined. A loop is then performed for each process (starting from the first one); the loop begins at block 418, wherein the location of the running module associated with the process is obtained. The metering agent then verifies at block 420 whether the location of the running module is included in the local catalogue (i.e., an entry exists for the corresponding hash value). If the result of the verification is negative the blocks 422-428 are executed, whereas the blocks 430-445 are executed otherwise; in both cases, the method then passes to block 446.

Considering now block 422, this point is reached when the running module is not included in the local catalogue; for example, this can occur if the running module has been installed on the workstation after the last update of the local catalogue. In this phase, the mass memory is scanned until the running module is found (thereby obtaining the corresponding path). A test is now made at block 424 to verify whether the running module is included in the global catalogue (according to its name only and/or any other attribute). If so, an entry for the path and the location of the running module is added to the local catalogue at block 426. Conversely, the running module is set as unknown at block 428; preferably, in this phase any information that can be obtained from the location of the running module (such as the name, and sometimes its size as well) is stored with the location of the (unknown) running module, so as to facilitate its identification (for example, by an administrator). In both cases, the flow of activity then descends into block 446.

With reference instead to block 430 (running module included in the local catalogue), the path corresponding to the location of the running module is extracted from the local catalogue. Continuing to block 432, the metering agent accesses the module corresponding to the extracted path, so as to determine its location (operation very fast). The determined location is then compared at block 434 with the location of the running module. If the result of the comparison is negative the blocks 436-444 are executed, whereas the block 445 is executed otherwise; in both cases, the method then passes to block 446.

Considering now block 436, this point is reached when the path associated with the location of the running module in the local catalogue is not valid any longer; for example, this can occur if the running module has been moved after the last update of the local catalogue. In this case, the (invalid) entry for the location of the running module is removed from the local catalogue at block 436. The method then continues to block 438, wherein the mass memory is scanned until the running module is found (thereby obtaining the corresponding path). A test is now made at block 444 to verify whether the running module is included in the global catalogue. If so, an entry for the path and the location of the running module is added to the local catalogue at block 442. Conversely, the running module is set as unknown at block 444 (together with any relevant information that is available), since its usage is not to be metered any longer. In both cases, the flow of activity then descends into block 446.

With reference instead to block 445 (path associated with the location of the running module still valid), this path is accepted as the correct one for accessing the running module. The method then passes to block 446.

As a result, the local catalogue is automatically updated to reflect the installation of any new product (block 426) or the moving of the module associated with any product already installed (blocks 436 and 442). In any case, those events are not very frequent (especially the moving of the modules), so that the corresponding (slow) scanning of the mass memory will occur very seldom. It should be noted that the above-described algorithm is unable to remove the entries from the local catalogue corresponding to any products that have been disinstalled (since their modules will never run); however, this obsolete information is removed periodically when the local catalogue is re-created (block 414).

Considering now block 446, the running module can now be accessed through the path so obtained (assuming that it is not unknown); in this way, it is possible to extract each attribute of the running module specified in the global catalogue (its size and checksum in the example at issue). The extracted attributes are then compared at block 448 with the corresponding values specified in the global catalogue for the module (or the modules) with the same name (being always available as a result of the above-described logic flow). If the attributes of the running module match the ones indicated in the global catalogue, the corresponding product is identified at block 450. Conversely, the product is set as unknown at block 452 (together with any available information). A test is then made at block 453 to verify whether all the processes have been analyzed. If not, the method returns to block 418 for repeating the same operations for the running module of a next process.

Once all the running modules have been processed, the information so obtained is notified to the licensing manager at block 454. In response thereto, the licensing manager at block 456 verifies whether the execution of each identified product on the workstation complies with the conditions of use stored in the authorization catalogue (for example, whether the execution environment meets the authorized configuration and the number of instances of the product already running does not reach the maximum allowable value); conversely, any unknown product is deemed non-authorized by default (or the administrator is prompted to define its authorization at run-time). The result of the verification is logged at block 458; at the same time, any granted authorization is also added to the running table. In this phase, it is further possible to notify any critical condition to the administrator (for example, when the number of available licenses for any product falls below a threshold value or when the licensing server has run out of licenses for a specific product). A corresponding response is then returned to the metering agent at block 460.

A loop is then performed for each process (starting from the first one); the loop begins at block 461, wherein the corresponding authorization to run is checked. If the authorization has not been granted (block 464), the process is closed at block 466 (thereby stopping the execution of the corresponding product); on the contrary, no operation is performed (so that the execution of the program can continue). In any case, a test is then made at block 468 to verify whether all the processes have been checked. If not, the method returns to block 461 for repeating the same operations for a next process. Conversely, the flow of activity returns to the waiting block 416.

Naturally, in order to satisfy local and specific requirements, a person skilled in the art may apply to the solution described above many modifications and alterations. Particularly, although the present invention has been described with a certain degree of particularity with reference to preferred embodiment(s) thereof, it should be understood that various omissions, substitutions and changes in the form and details as well as other embodiments are possible; moreover, it is expressly intended that specific elements and/or method steps described in connection with any disclosed embodiment of the invention may be incorporated in any other embodiment as a general matter of design choice.

For example, the use of the proposed solution in a context different than the licensing management is contemplated. Particularly, the information that has been detected about the products can be used for reporting purposes only (without any verification of their authorizations). Alternatively, the products are always allowed to run (for example, only logging an exception when their usage is not authorized).

In any case, the method of the invention can be used to meter any kind of software products (such as video games, multimedia works, and the like).

Similar considerations apply the system has a different structure or it is based on equivalent elements; likewise, each workstation can have another structure or it can be replaced with any data processing entity (such as a PDA, a mobile phone, and the like). Moreover, the solution of the invention is also suitable to be used in a system wherein the control of the workstations is decentralized, or even in a stand-alone computer.

It should be noted that the principles of the invention are not restricted to the above-specified paths and locations, but they apply more generally to any equivalent element (in whatever file system) for accessing the modules and for their identification when running, respectively.

Even though in the preceding description reference has been made to a global catalogue and to a local catalogue, this is not to be intended in a limitative manner; indeed, the solution of the invention is suitable to be implemented with any other structure, even consisting of a single catalogue (for example, by adding the paths to the relevant entries of the global catalogue).

In any case, equivalent executable modules can be taken into considerations (such as DLLs); moreover, the modules can be identified in the global catalogue with different attributes (for example, their creation date).

Alternatively, the use of any other technique for scanning the mass memory of the system (when required) is within the scope of the invention (for example, comparing all the attributes and not only the name of the relevant modules).

Similar considerations apply if the program implementing the above-described solution is structured in a different way, or if additional blocks or functions are provided; likewise, the different memory structures can be of different types, or can be replaced with equivalent entities (not necessarily consisting of physical storage media). Moreover, the proposed solution can implement an equivalent method (for example, with similar or additional steps).

In any case, it is possible to distribute the programs in any other computer readable medium (such as a DVD).

Moreover, it will be apparent to those skilled in the art that the additional features providing further advantages are not essential for carrying out the invention, and may be omitted or replaced with different features.

For example, the proposed solution is also suitable to be applied when the launching of each module is intercepted at run-time (even if in this case alternative techniques are available for obtaining the path of the running modules).

In an alternative embodiment of the invention, the names of the products are stored directly in the local catalogue (so that they can be identified without having to access the global catalogue physically at run-time).

Without departing from the principles of the invention, it is possible to create the local catalogue incrementally. For example, an empty local catalogue is provided on a pristine workstation and a new entry is inserted whenever a product is installed (assuming that a notification mechanism is in place); therefore, the location of any running module will be always included in the local catalogue.

However, a simplified implementation where the product is simply set as unknown whenever it is not found in the local catalogue is not excluded.

In addition, the product can also be set as unknown whenever the path associated with the location of the running module in the local catalogue is not valid any longer

Alternatively, when the above-mentioned notification mechanism is in place it is possible to update the local catalogue in response to any change (for example, the deleting or the moving of each module). In this way, any association in the local catalogue will be always valid; therefore, any (slow) scanning of the mass memory at run-time can be avoided.

Without departing from the principles of the invention, it is also possible to accept the path extracted from local catalogue without any verification (considering that the modules are moved very seldom, so that the probability of having an invalid association is negligible in most practical situations).

Similar considerations apply if the programs are pre-loaded onto the hard disks, are sent to the computers through the network, are broadcast, or more generally are provided in any other form directly loadable into the working memories of the computers.

At the end, the method according to the present invention leads itself to be carried out with a hardware structure (for example, integrated in chips of semiconductor material), or with a combination of software and hardware.

1. A method for metering usage of software products in a data processing system, the method including the steps of:
providing a global catalogue associating each product to be metered with at least one executable module indicating the usage of the product when running,
creating a local catalogue associating a path for accessing each module installed on the system being included in the global catalogue with a location for identifying the module when running,
detecting the location of each module running on the system,
determining the path associated with the location of each running module according to the local catalogue, and
accessing each running module through the corresponding path for identifying the product associated with the running module according to the global catalogue.

2. The method according to claim 1, wherein the step of detecting the location of each running module includes:
periodically determining a list of processes in execution on the system, each process being associated with the location of a corresponding running module, and
obtaining the location of the running module associated with each process.

3. The method according to claim 1, wherein each module is defined in the global catalogue by means of at least one attribute, the step of accessing each running module for identifying the product associated with the running module including:
retrieving the at least one attribute of the running module, and
searching the product matching the at least one attribute of the running module in the global catalogue.

4. The method according to claim 1, wherein the step of creating the local catalogue includes:
scanning a mass memory of the system for detecting the path and the location of each installed module,
verifying whether each installed module is included in the global catalogue, and
adding the path and the location of each installed module to the local catalogue in response to a positive verification of the inclusion of the installed module in the global catalogue.

5. The method according to claim 4, wherein the step of determining the path associated with the location of each running module includes:
verifying whether the location of the running module is included in the local catalogue,
scanning the mass memory for detecting the path associated with the location of the running module in response to a negative verification of the inclusion of the location of the running module in the local catalogue,
verifying whether the running module is included in the global catalogue, and
adding the path and the location of the running module to the local catalogue in response to a positive verification of the inclusion of the running module in the global catalogue.

6. The method according to claim 4, wherein the step of determining the path associated with the location of each running module further includes:
extracting the path corresponding to the location of the running module from the local catalogue in response to a positive verification of the inclusion of the location of the running module in the local catalogue,
determining the location of the module accessed through the extracted path,
comparing the determined location with the location of the running module, and
associating the extracted path with the location of the running module in response to a positive result of the comparison.

7. The method according to claim 6, wherein the step of determining the path associated with the location of each running module further includes:
removing the location of the running module with the corresponding path from the local catalogue in response to a negative result of the comparison,
scanning the mass memory for detecting the path associated with the location of the running module,
verifying whether the running module is included in the global catalogue, and
adding the path and the location of the running module to the local catalogue in response to a positive verification of the inclusion of the running module in the global catalogue.

8. (canceled)

9. A computer program in a computer readable medium directly loadable into a working memory of a data processing system for performing a method for metering usage of software products in the system when the program is run on the system, the method including the steps of:
providing a global catalogue associating each product to be metered with at least one executable module indicating the usage of the product when running,
creating a local catalogue associating a path for accessing each module installed on the system being included in the global catalogue with a location for identifying the module when running,
detecting the location of each module running on the system,
determining the path associated with the location of each running module according to the local catalogue, and
accessing each running module through the corresponding path for identifying the product associated with the running module according to the global catalogue.

10. A data processing system including means for metering usage of software products in the system, the means for metering including:
a global catalogue associating each product to be metered with at least one executable module indicating the usage of the product when running,
means for creating a local catalogue associating a path for accessing each module installed on the system being included in the global catalogue with a location for identifying the module when running,
means for detecting the location of each module running on the system,
means for determining the path associated with the location of each running module according to the local catalogue, and
means for accessing each running module through the corresponding path for identifying the product associated with the running module according to the global catalogue.
